(19) United States
(12) Patent Application Publication
(10) Pub. No.: US 2025/0123529 A1
(43) Pub. Date: Apr. 17, 2025

(54) INTEGRATED WINDOW SENSORS

(71) Applicant: SAGE Electrochromics, Inc., Faribault, MN (US)

(72) Inventor: Bryan D. Greer, Northfield, MN (US)

(73) Assignee: SAGE Electrochromics, Inc., Faribault, MN (US)

(21) Appl. No.: 18/824,801

(22) Filed: Sep. 4, 2024

Related U.S. Application Data
(60) Provisional application No. 63/589,882, filed on Oct. 12, 2023.

(51) Int. Cl. G02F 1/163; G01J 1/02; G01J 1/42

(52) U.S. Cl. CPC G02F 1/163; G01J 1/0266; G01J 1/4204; G01J 2001/4266

(57) ABSTRACT

A system with one or more smart glass units is provided. The system includes a smart glass unit having at least one pane. The system also includes a multi-directional light sensor. The multi-directional light sensor includes a sensor element facing in a direction orthogonal to a surface of the pane. The multi-directional sensor also includes a plurality of other sensor elements facing in different directions that are parallel to the surface of the pane.

### PRIORITY APPLICATION

This application claims benefit of priority to U.S. Provisional Application Ser. No. 63/589,882, entitled “Integrated Window Sensors,” filed Oct. 12, 2023, and which is hereby incorporated herein by reference in its entirety.

### FIELD OF THE DISCLOSURE

The present disclosure is directed to one or more smart glass units, and more specifically to various approaches for sensing light through smart glass units and controlling a tint of the smart glass units based on the amount of sensed light.

### BACKGROUND

Smart glass may be used to decrease heat transfer through a window and/or reduce the transmission of visible light to provide tinting or shading. Smart glass (e.g., an electrochromic (EC) device, an electrochromic insulated glass unit (EC-IGU), a device with a glass that changes, for example tint, in response to an input, an electrical charge, and/or the environment) may be used to provide a decrease in solar heat gain through a transparent substrate and a reduction in visible light transmission through a transparent substrate (e.g., a window or glass pane). An EC device may include EC materials that are known to change their optical properties, such as coloration, in response to the application of an electrical potential, thereby making the transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied. Complex tinting control schedules for maintaining a desired amount of tinting through a smart glass unit throughout individual days, throughout an entire year, and with varying weather conditions can be time consuming and labor intensive to customize for individual and/or groups of smart glass units and can also lead to errors where instances of undesirable tint levels occur.

### SUMMARY

In some aspects, a system is provided. The system includes a smart glass unit having at least one pane. The system also includes a multi-directional light sensor. The multi-directional sensor includes a sensor element facing in a direction orthogonal to a surface of the pane. The multi-directional sensor also includes a plurality of other sensor elements facing in different directions that are parallel to the surface of the pane.

In some aspects, the sensor element includes a first sensor element. In some aspects, the plurality of other sensor elements includes a second sensor element, a third sensor element, and a fourth sensor element. The second sensor element faces in an upward direction when the smart glass unit is installed in a wall of a building. The third sensor element faces in a first lateral direction when the smart glass unit is installed in the wall of the building. The fourth sensor element faces in a second lateral direction, opposite the first lateral direction, when the smart glass unit is installed in the wall of the building. In some aspects, when the smart glass unit is installed in a wall of a building, the sensor element faces in the direction orthogonal to the surface of the pane and towards an exterior area of the building. In some aspects, the multi-directional light sensor is positioned at a central lower edge of the pane. In some aspects, at least some of the plurality of other sensor elements face in directions that are orthogonal to each other. In some aspects, the system further includes an existing window-pane. The smart glass unit includes a retrofit smart glass unit. The retrofit smart glass unit is positioned adjacent an interior surface of the existing window-pane. The multi-directional light sensor is positioned between the existing window-pane and the retrofit smart glass unit. In some aspects, the sensor element and the plurality of other sensor elements are configured to detect at least one of a total light radiation, sunny and cloud conditions, or a solar angle.

In some aspects, a system is provided. The system includes a smart glass unit configured to modulate a tint for permitting light to pass therethrough. The system also includes a multi-directional light sensor. The multi-directional light sensor includes a sensor element facing in a direction orthogonal to a surface of the smart glass unit. The multi-directional light sensor also includes a plurality of other sensor elements facing in different directions that are orthogonal to the direction that the sensor element faces. The system further includes a controller. The controller is configured to receive one or more signals indicating an amount of light detected by respective sensor elements of the sensor element and of the plurality of other sensor elements. The controller is also configured to generate one or more tint signals for controlling a tint of the smart glass unit based on the one or more signals.

In some aspects, the one or more tint signals for controlling the tint of the smart glass unit are based on an angle by which the smart glass unit receives light from a light source. In some aspects, the plurality of other sensor elements includes three other sensor elements. Generating the one or more tint signals for controlling the tint of the smart glass unit based on the one or more signals includes determining a total amount of radiation received by the sensor element and the plurality of other sensor elements, identifying that a first sensor element detects a lowest amount radiation compared to remaining sensor elements among the sensor element and the plurality of other sensor elements, subtracting the lowest amount of radiation from the total amount of radiation to obtain an amount of direct radiation received by the smart glass unit, and determining the angle by which the smart glass unit receives the light from the light source based on the direct radiation and directions that the respective remaining sensor elements face among the sensor element and the plurality of other sensor elements. In some aspects, the one or more tint signals indicates a total received radiation. In some aspects, the one or more tint signals indicates an amount of cloud cover in an external environment. In some aspects, the controller is positioned within or adjacent to the smart glass unit. In some aspects, the controller is positioned at a location remote from the smart glass unit. In some aspects, the controller is positioned within or adjacent to the multi-directional light sensor. In some aspects, the sensor element includes a first sensor element. The plurality of other sensor elements includes a second sensor element, a third sensor element, and a fourth sensor element. The second sensor element faces in an upward direction when the smart glass unit is installed in a wall of a building. The third sensor element faces in a first lateral direction when the smart glass unit is installed in the wall of the building. The fourth sensor element faces in a second lateral direction, opposite the first lateral direction, when the smart glass unit is installed in the wall of the building. In some aspects, when the smart glass unit is installed in a wall of a building, the sensor element faces in the direction orthogonal to the surface of the smart glass unit and towards an exterior area of the building. In some aspects, the multi-directional light sensor is positioned at a central lower edge of a pane of the smart glass unit. In some aspects, at least some of the plurality of other sensor elements face in directions that are orthogonal to each other.

In some aspects, a method is provided. The method includes receiving, by a controller, one or more signals from respective sensor elements of a plurality of sensor elements indicating an amount of light sensed by the respective sensor elements. The respective sensor elements of the plurality of sensor elements are oriented in different directions. The method also includes determining, by the controller, light information for a location. The light information is determined based on the amount of light sensed by the respective sensor elements and the different orientations of the respective sensor elements. The light information includes one or more of an angular position of a direct light source with respect to the location, or information relating an amount of direct light to an amount of indirect light at the location. The method further includes sending, by the controller, one or more control signals to at least one smart glass unit to control a level of tint of the at least one smart glass unit based on the determined light information.

In some aspects, determining, by the controller, the information relating the amount of direct light to the amount of indirect light at the location includes determining, by the controller, a lowest amount light received by one sensor element of the plurality of sensor elements compared to remaining sensor elements of the plurality of sensor elements, and subtracting the lowest amount of light from a total amount of light received by the sensor element at the location to obtain the amount of direct light received by the sensor element at the location. In some aspects, the plurality of sensor elements comprises three sensor elements. In some aspects, the plurality of sensor elements includes at least four sensor elements, and the method further includes determining, by the controller, whether an external environment includes one of a cloudy condition or a sunny condition. In some aspects, determining, by the controller, that the external environment includes the cloudy condition includes determining that the respective sensor elements of the plurality of sensor elements sense a same or similar amount of light based on the one or more signals indicating the amount of light sensed by the respective sensor elements, and determining that the external environment includes the cloudy condition based on the respective sensor elements of the plurality of sensor elements sensing the same or similar amount of light. In some aspects, determining, by the controller, that the external environment includes the sunny condition includes determining that at least one sensor element of the plurality of sensor elements senses a different amount of light compared to at least one other sensor element of the plurality of sensor elements based on the one or more signals indicating the amount of light sensed by the respective sensor elements, and determining that the external environment includes the sunny condition based on the at least one sensor element of the plurality of sensor elements sensing the different amount of light compared to the at least one other sensor element of the plurality of sensor elements. In some aspects, the plurality of sensor elements are components of a unitary multi-directional sensor.

### BRIEF DESCRIPTION OF THE DRAWINGS

FIG. 1 illustrates a perspective cross-sectional view of an example EC system according to some aspects of this disclosure.

FIG. 2 illustrates a perspective view of an example system according to some aspects of this disclosure.

FIG. 3 illustrates a block diagram of an example system according to some aspects of this disclosure.

FIG. 4 illustrates a perspective view of an example system including a multi-directional sensor according to some aspects of this disclosure.

FIG. 5 illustrates a perspective view of another example system including a multi-directional sensor according to some aspects of this disclosure.

FIG. 6 illustrates a perspective view of an example system according to some aspects of this disclosure.

FIG. 7 illustrates a perspective view of an example system according to some aspects of this disclosure.

FIG. 8 illustrates a cross-sectional view of an example system according to some aspects of this disclosure.

FIG. 9 illustrates an example method according to some aspects of this disclosure.

FIG. 10 illustrates an example computer system that may be used in some embodiments.

This specification may include references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units.” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value. It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will further be understood that the term “or” as used herein refers to and encompasses alternative combinations as well as any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. For example, the words “include,” “including,” and “includes” indicate open-ended relationships and therefore mean including, but not limited to. Similarly, the words “have,” “having,” and “has” also indicate open-ended relationships, and thus mean having, but not limited to.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Whenever a relative term, such as “about”, “substantially” or “approximately”, is used in this specification, such a term should also be construed to also include the exact term. That is, e.g., “substantially straight” should be construed to also include “(exactly) straight”. As used herein, the terms “about”, “substantially”, or “approximately” (and other relative terms) may be interpreted in light of the specification and/or by those having ordinary skill in the art. In some examples, such terms may be as much as 1%, 3%, 5%, 7%, or 10% different from the respective exact term.

While embodiments are described herein by way of example for several embodiments and illustrative drawings, those skilled in the art will recognize that the embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. Any headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must).

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

Smart glass may be used to decrease heat transfer through a window and/or reduce the transmission of visible light to provide tinting or shading. A smart glass system including a smart glass (e.g., an electrochromic (EC) device, an electrochromic insulated glass unit (EC-IGU), a device with a glass that changes, for example tint, in response to an input, an electrical charge, and/or the environment) may be used to provide a decrease in solar heat gain (e.g., increase in insulation) through a transparent substrate and a reduction in visible light transmission through a transparent substrate (e.g., a window or glass pane). An EC device may include EC materials that are known to change their optical properties, such as coloration, in response to the application of an electrical potential, thereby making the transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied. Many smart glass units and smart glass unit systems rely on complicated and customized tint control schedules and complex three-dimensional models of buildings (e.g., to determine when there is shade and direct sun in specific locations) to control tint levels to meet desired tinting parameters of building occupants.

Configuring controllers (e.g., controllers for controlling individual or groups of smart glass units, system controllers for directing a plurality of controllers to controller individual or groups of smart glass units) for scheduling tint controller operations for individual smart glass units or groups of smart glass units among a plurality of smart glass units positioned at different locations on a building or across several different buildings can be time and/or labor intensive. For example, a group of buildings may use several hundred smart glass units to provide modulated tinting for occupants. Each of the different smart glass units may face in different directions and thus receive sunlight at different angles throughout the day and/or throughout different times of the year, receive more shade than one or more other smart glass units due to their respective proximities to a tree, another building, and/or another obstruction, receive shade at different times of the day due and/or at different times of the year due to their respective proximities to a tree, another building and/or another obstruction, and/or the like. As such, designing and implementing tint control schedules for each individual smart glass unit or even for groups of smart glass units can be time consuming, expensive, and prone to error. Also, designing and implementing tint control schedules for each individual smart glass unit or even for groups of smart glass units may not adequately provide a desirable amount to tinting for the occupants inside the building(s).

As described herein, a smart glass unit system and/or a smart glass unit is provided that includes a multi-directional sensor. For a respective smart glass unit and/or for a respective group of smart glass units, the multi-directional sensor is configured to sense total radiation received and/or an angle from which solar radiation is received. The angles from which solar radiation is received by the multi-directional sensor may be used to determine glare and if the smart glass unit is to be tinted to reduce or block glare. Thus, for example, total radiation from an external environment and/or an angle by which radiation or light from a light source (e.g., the Sun) in the external environment reaches the multi-directional sensor, and thus the smart glass unit (e.g., a pane of the smart glass unit), may be sensed for controlling a tint level of the smart glass unit. When the smart glass unit is installed in a wall of a building separating an internal environment within the building from the external environment outside the building, measurements taken by the multi-directional sensor may be used to control the tint level of the smart glass unit. The measurements may be taken from the multi-directional sensor to regulate the amount of light that passes from the light source in the external environment, through the smart glass unit, and into the internal environment of the building to a desirable level for the occupants therein. The multi-directional sensor may take light measurements at a surface of the smart glass unit to allow for the regulation or control of the tint level of the smart glass unit on a unit-by-unit basis without the complex control scheduling that would otherwise be used. Accordingly, using the multi-directional sensor, knowing the amount of shade that the smart glass unit receives, the location of the Sun at a particular time of day at a particular time of year, and/or which direction the smart glass unit is facing may no longer be needed to control the level of tint of the smart glass unit to provide a desirable amount of tinting therethrough.

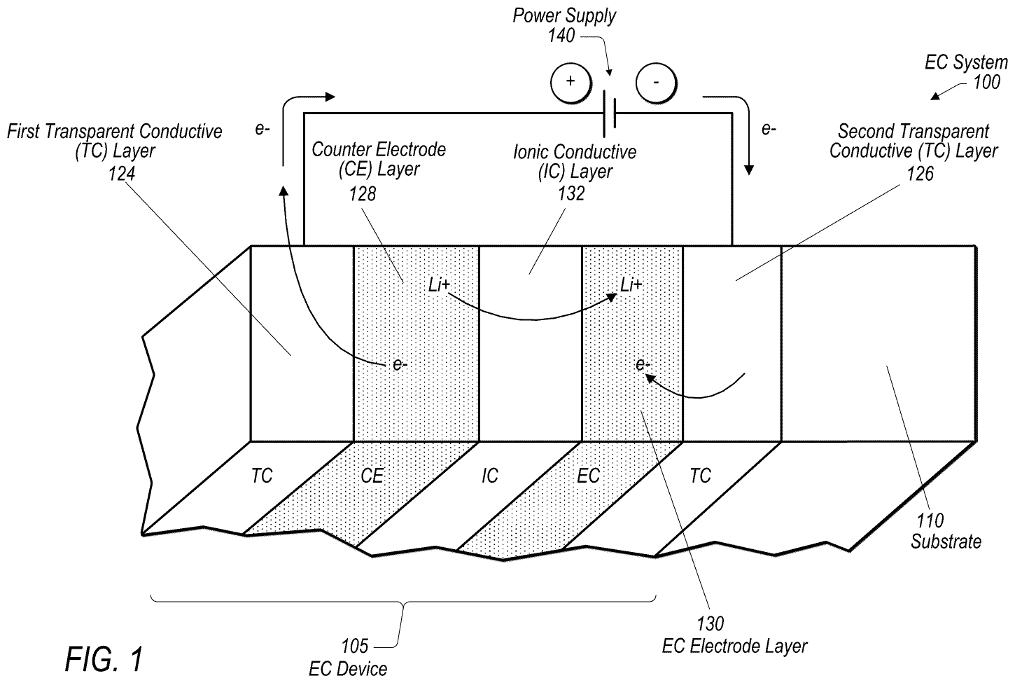

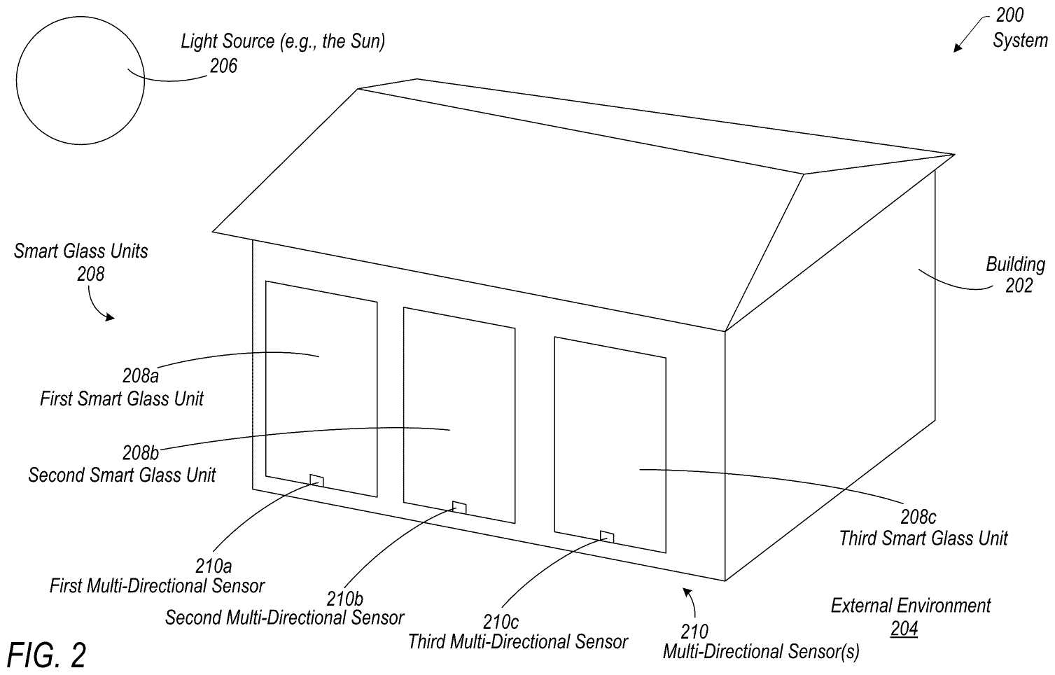

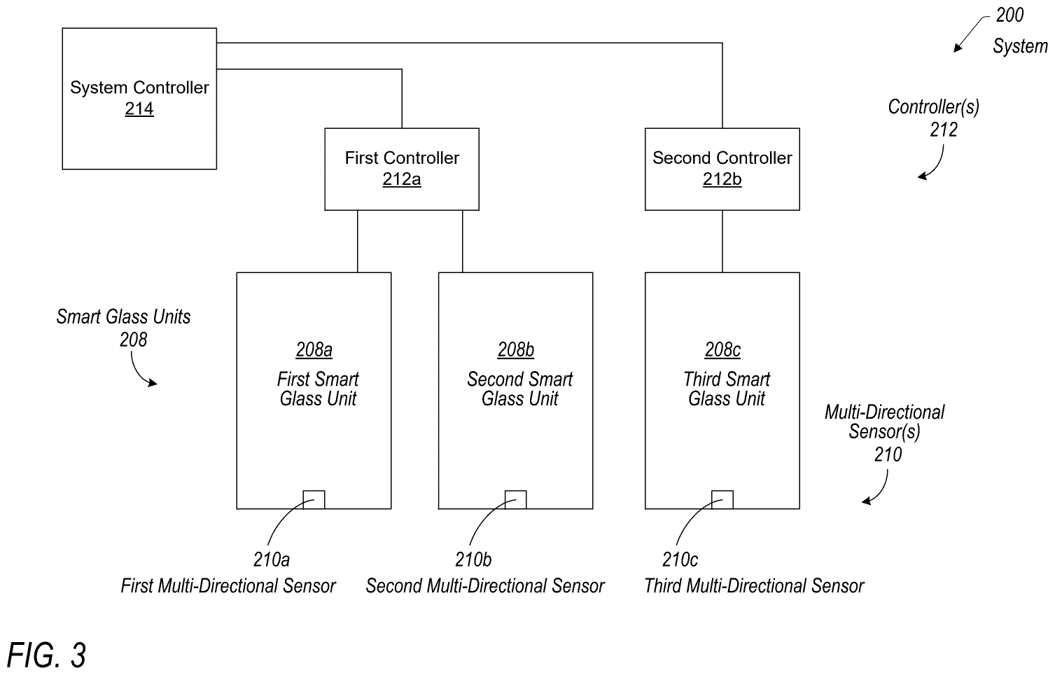

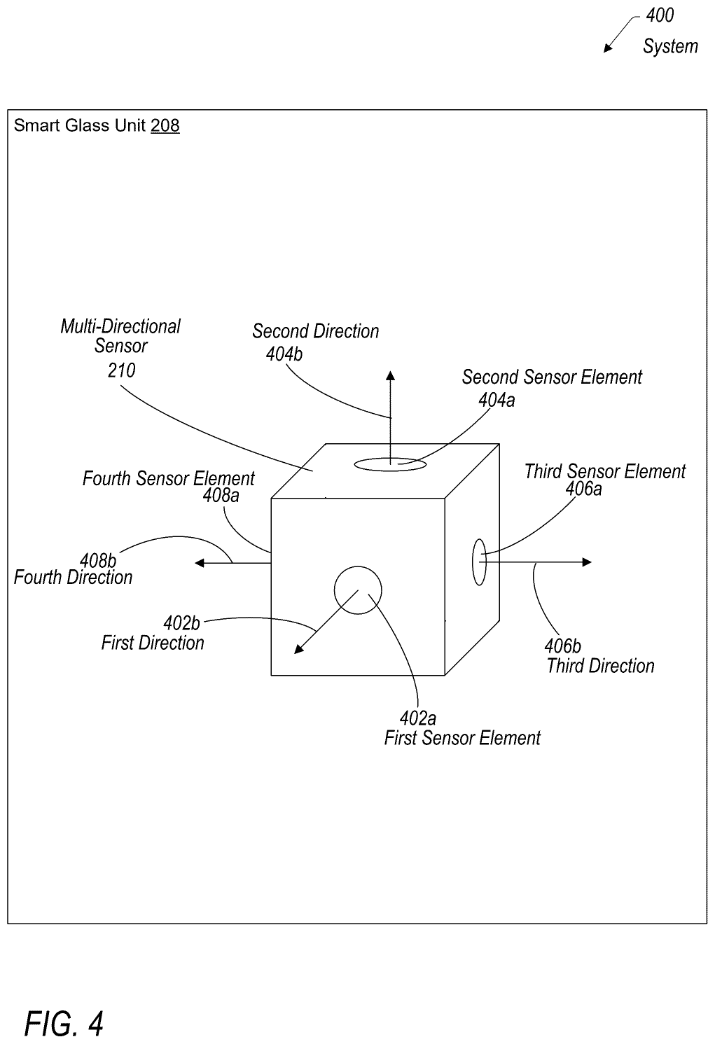

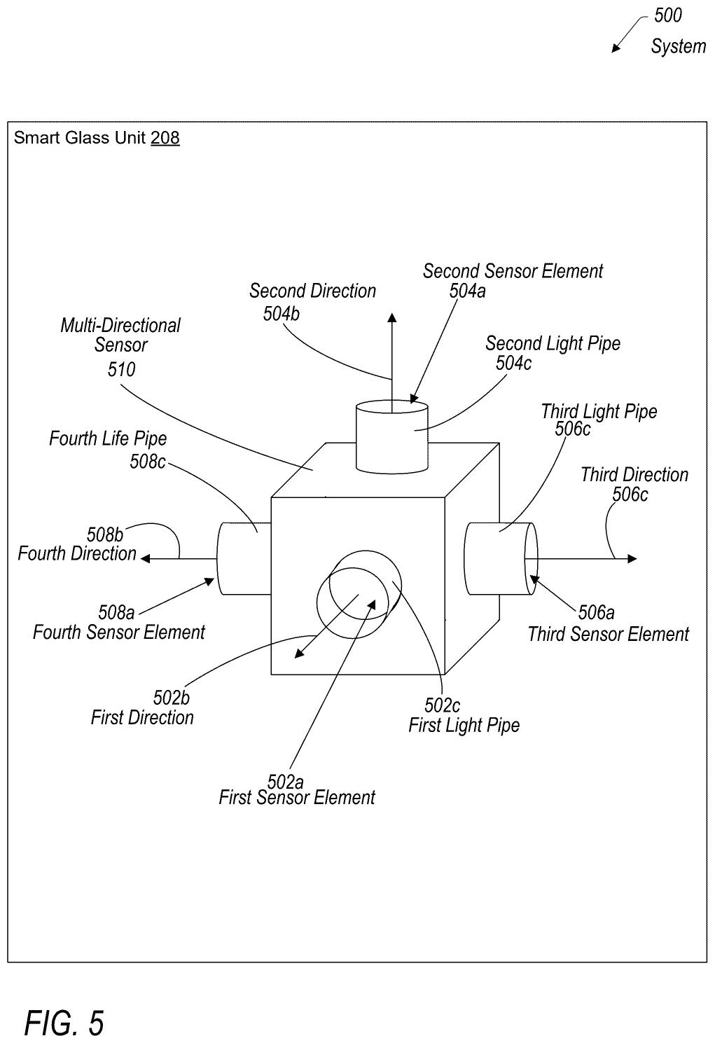

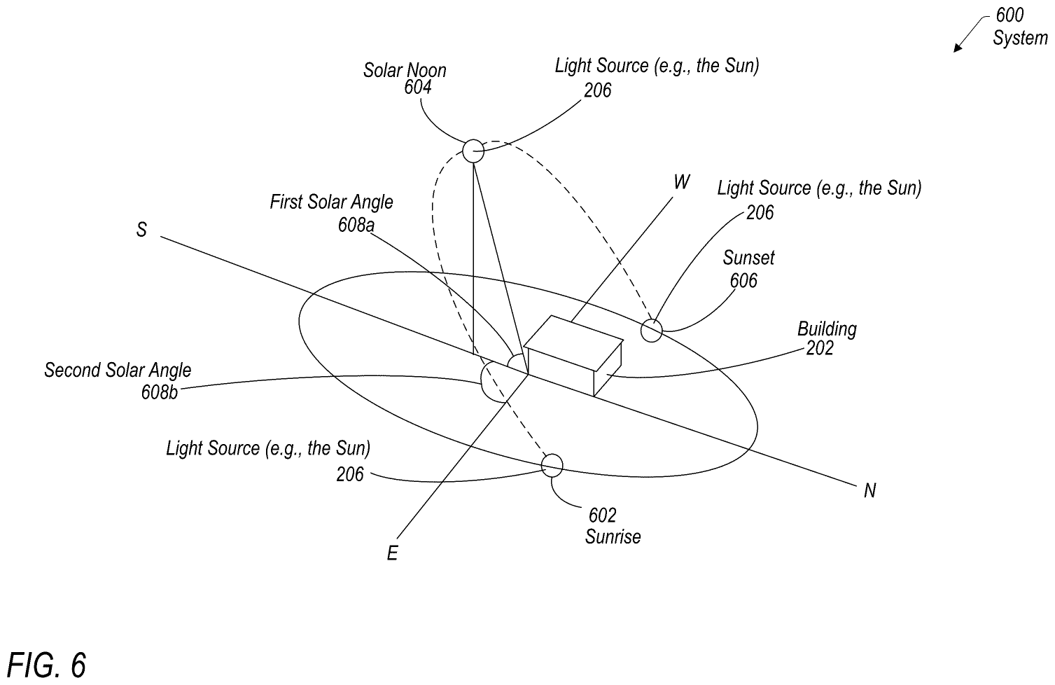

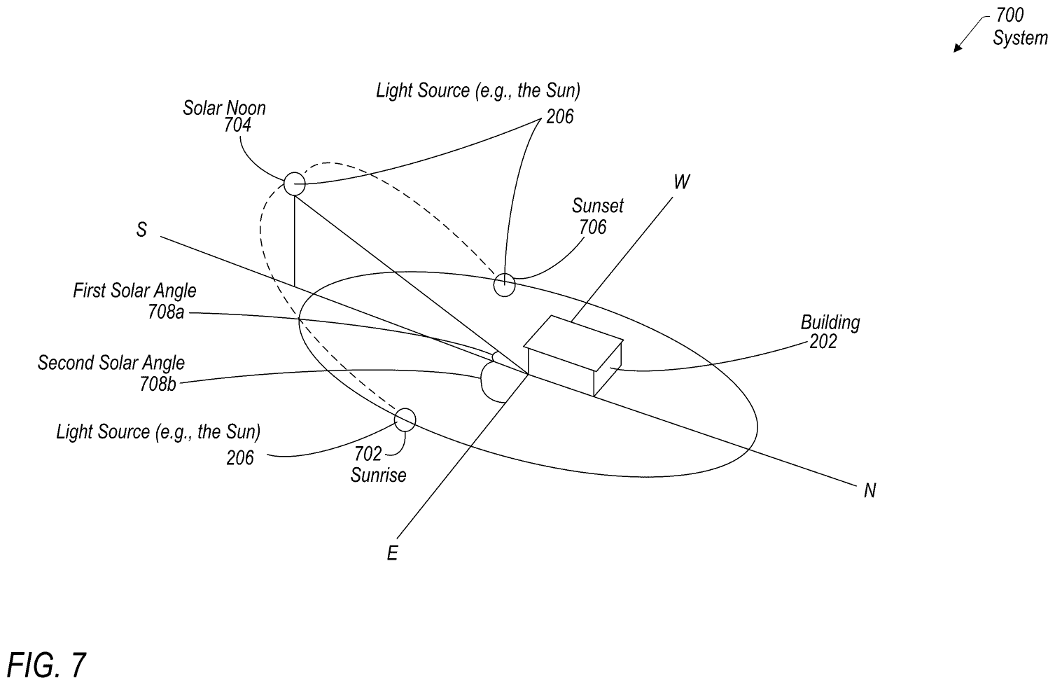

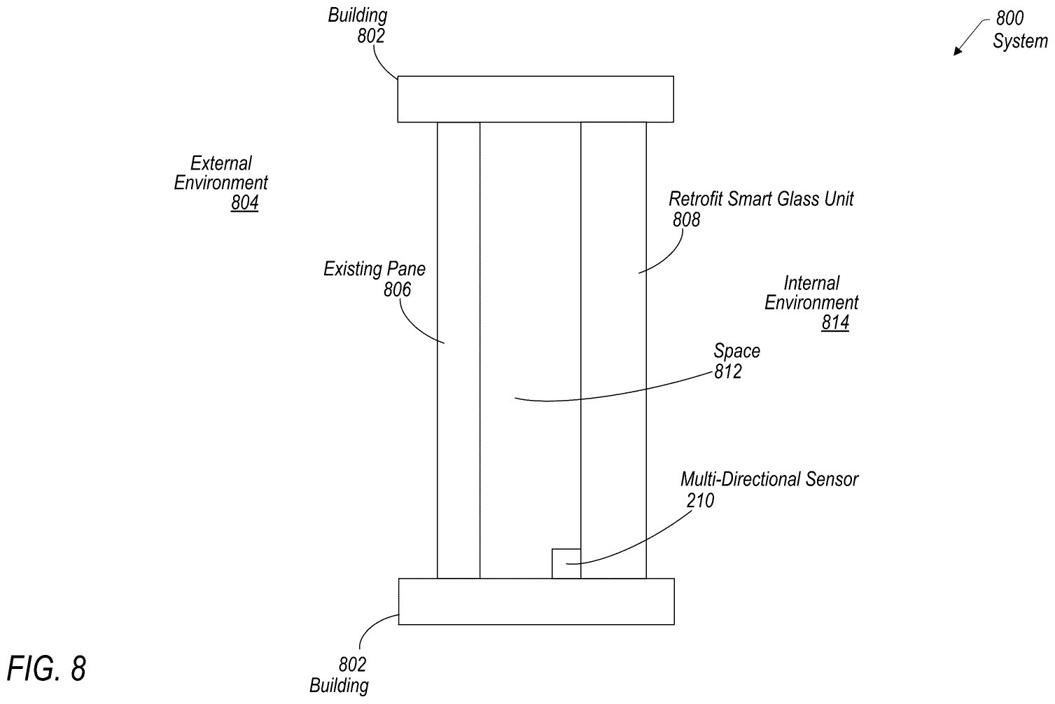

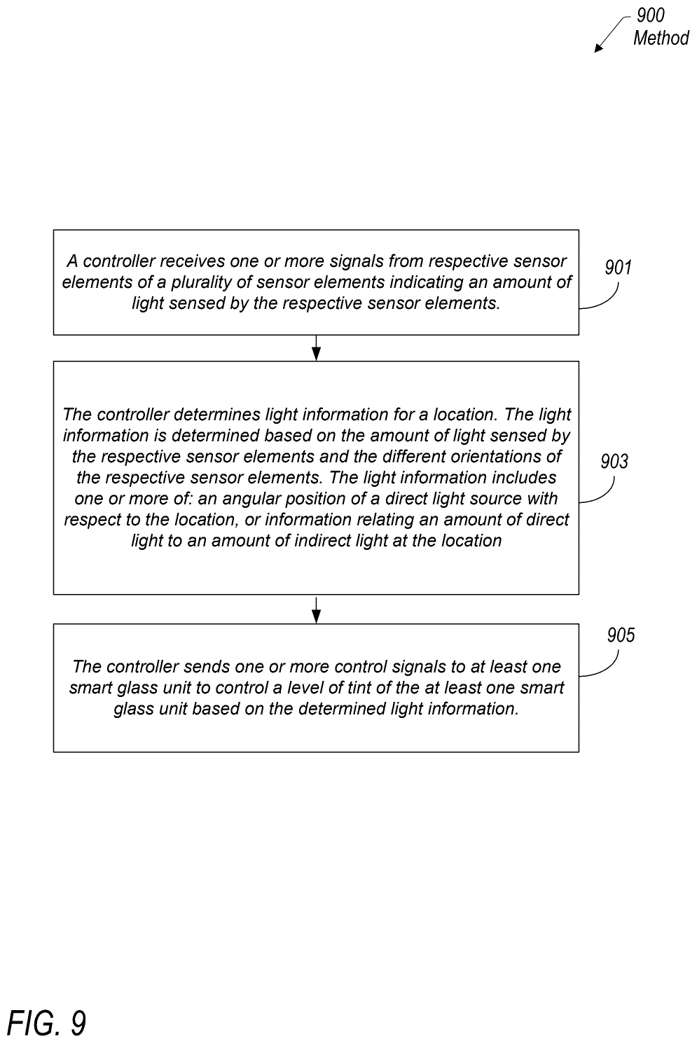

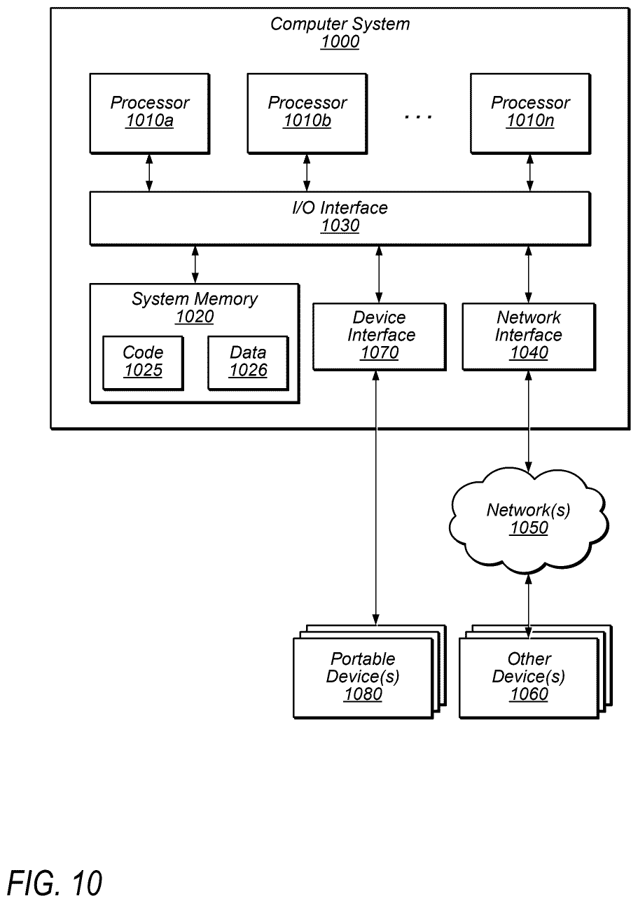

FIG. 1 illustrates a perspective cross-sectional view of an example EC system 100 according to some aspects of this disclosure. The EC system 100 may include one or more same or similar features as the features described with respect to or illustrated in FIGS. 2, 3, 4, 5, 6, 7, 8, 9, and 10. For example, the EC system 100 may include one or more same or similar features as the features described with respect to the system 200 of FIGS. 2 and 3, the system 400 of FIG. 4, the system 500 of FIG. 5, the system 600 of FIG. 6, the system 700 of FIG. 7, the system 800 of FIG. 8, and/or the computer system 1000 of FIG. 10. The EC 100 of FIG. 1 and the description provided therewith may be implemented with one or more of the steps of the method 900 of FIG. 9 or used to at least partially perform one or more of the steps of the method 900 of FIG. 9. FIG. 1, as with the other included figures, is shown for illustrative purposes and does not limit either the possible embodiments of the present invention or the claims.

In this example, the EC system 100 may include an EC device 105 secured to a substrate 110. The EC device 105 may be a non-limiting example of a smart glass or smart glass unit as provided herein. The EC device 105 may include a thin film which may be deposited on to the substrate 110. The EC device 105 may include a first transparent conductive (TC) layer 124 and a second TC layer 126 in contact with the substrate 110. In some aspects, the first TC layer 124 and the second TC layer 126 may be, or may include, one or more transparent conductive oxide (TCO) layers. The substrate 110 may include one or more optically transparent materials, e.g., glass, plastic, and the like. The EC device 105 may also include one or more active layers. For example, the EC device 105 may include a counter electrode (CE) layer 128 in contact with the first TC layer 124 and an EC electrode layer 130 in contact with the second TC layer 126. An ionic conductor (IC) layer 132 may be positioned in-between (e.g., “sandwiched” between) the CE layer 128 and the EC electrode layer 130. The EC system 100 may include a power supply 140 which may provide regulated current or voltage to the EC device 105. Transparency of the EC device 105 may be controlled by regulating density of charges (or lithium ions) in the CE layer 128 and/or the EC electrode layer 130 of the EC device 105. For instance, when the EC system 100 applies a positive voltage from the power supply 140 to the first TC layer 124, lithium ions may be inserted into the EC electrode layer 130. In some aspects, when the EC system 100 applies a positive voltage from the power supply 140 to the first TC layer 124, lithium ions may be driven across the IC layer 132 and inserted into the EC electrode layer 130. Simultaneously, charge-compensating electrons may be extracted from the CE layer 128, may flow across the external circuit, and may flow into the EC electrode layer 130. Transfer of lithium ions and associated electrons from the CE layer 128 to the EC electrode layer 130 may cause the EC device 105 to become darker—e.g., the visible light transmission of the EC device 105 may decrease. Reversing the voltage polarity may cause the lithium ions and associated charges to return to their original layer, the CE layer 128, and as a result, the EC device 105 may return to a clear state—e.g., the visible light transmission of the EC device 105 may increase.

As described herein, a smart glass or device such as the EC device 105 of FIG. 1 may receive a charge (e.g., a voltage) for controlling a tint of the smart glass. For example, an electrical charge may be provided to a smart glass to increase a level of tint (e.g., darken) of the smart glass. As another example, an electrical charge may be provided to a smart glass to maintain a level of tint of the smart glass. As yet another example, an electrical charge may be provided to a smart glass to decrease a level of tint of the smart glass. As another example, an electrical charge may be provided to a smart glass to clear a tint of the smart glass.

FIG. 2 illustrates a perspective view of an example system 200 according to some aspects of this disclosure. FIG. 3 illustrates a block diagram of the example system 200 according to some aspects of this disclosure. The system 200 may include one or more same or similar features as the features described with respect to or illustrated in FIGS. 1, 4, 5, 6, 7, 8, 9, and 10. For example, the system 200 may include one or more same or similar features as the features described with respect to the EC system 100 of FIG. 1, the system 400 of FIG. 4, the system 500 of FIG. 5, the system 600 of FIG. 6, the system 700 of FIG. 7, the system 800 of FIG. 8, and/or the computer system 1000 of FIG. 10. The system 200 of FIGS. 2 and 3 and the description provided therewith may be implemented with one or more of the steps of the method 900 of FIG. 9 or used to at least partially perform one or more of the steps of the method 900 of FIG. 9. FIGS. 2 and 3, as with the other included figures, are shown for illustrative purposes and do not limit either the possible embodiments of the present invention or the claims.

As shown in FIG. 2, the system 200 includes a building 202 separating an interior of the building 202 from the external environment 204. The external environment 204 may include a light source 206 (e.g., the Sun, a brightly lit building near the building 202, a street or park light near the building 202) emitting radiation (e.g., visible light) onto the building 202 and through a plurality of smart glass units 208 positioned on the building 202 into the interior of the building 202. The plurality of smart glass units 208 may include a first smart glass unit 208a, a second smart glass unit 208b, and a third smart glass unit 208c. Respective smart glass units of the plurality of smart glass units 208 may include a multi-directional sensor 210. For example, the first smart glass unit 208a may include a first multi-directional sensor 210a, the second smart glass unit 208b may include a second multi-directional sensor 210b, and the third smart glass unit 208c may include a third multi-directional sensor 210c. The multi-directional sensors 210 may include a plurality of sensor elements for measuring an amount of received light. For example, respective multi-directional sensors may include a sensor element facing in a direction orthogonal to a surface of the respective smart glass unit (e.g., a pane of the respective smart glass unit) and a plurality of other sensor elements facing in different directions that are parallel to the surface of the pane. In some aspects, the sensor element includes a first sensor element and the plurality of other sensor elements may include a second sensor element, a third sensor element, and a fourth sensor element. As such, the second sensor element may face in an upward direction when the respective smart glass unit 208 is installed in a wall of the building 202. The third sensor element may face in a first lateral direction when the respective smart glass unit 208 is installed in the wall of the building 202. The fourth sensor element may face in a second lateral direction, opposite the first lateral direction, when the respective smart glass unit 208 is installed in the wall of the building 202. In some aspects, the plurality of other sensor elements may face in directions that are orthogonal to at least one other sensor element. For example, the second sensor element may face in a direction orthogonal to the third sensor element or the fourth sensor element and the third sensor element may face in a direction orthogonal to the fourth sensor element. Additionally, or alternatively, the first sensor element may face in a direction orthogonal to the second sensor element, the third sensor element, and/or the fourth sensor element. In some aspects, when the respective smart glass unit 208 is installed in a wall of the building 202, the first sensor element faces in the direction orthogonal to the surface of the respective smart glass unit (e.g., a pane of the respective smart glass unit) and towards the exterior environment 204 (e.g., the exterior area) of the building 202.

In some aspects, the multi-directional sensor 210 may include a sensor element for measuring temperature. For example, in addition to the plurality of sensor elements for sensing an amount of light, the multi-directional sensor 210 may include a sensor element for measuring temperature. In some aspects, one or more of the sensor elements for sensing an amount of light may also be configured to measure temperature. In some aspects, a sensor element for measuring temperature may be orientated to face into the external environment 204. In some aspects, the sensor element for measuring temperature may be oriented to face away from the external environment 204 (e.g., to face towards the smart glass unit, to face toward the building 202, to face towards an internal environment of the building 202). In some aspects, using a sensor element to measure temperature, a controller (e.g., the first controller 212a, the second controller 212b, the system controller 214) may determine how much voltage is needed to control a tint of the smart glass unit (e.g., the first smart glass unit 208a, the second smart glass unit 208b, the third smart glass unit 208c). For example, on a relatively hotter day, a controller may need to provide a greater amount of voltage to a smart glass unit to control a tint of the smart glass unit compared to on a relatively cooler day.

Each of the multi-directional sensors 210 may be positioned against the respective smart glass units 208 to receive the same light (e.g., the same amount to light intensity, about the same amount of light intensity), for example from the light source 206, that is received by the respective smart glass units themselves. Also, each of the multi-directional sensors 210 may be positioned against the respective smart glass units 208 to receive the same light (e.g., the same amount to light intensity, about the same amount of light intensity) at the same or similar angle, for example from the light source 206, that the respective smart glass units themselves receive the light. The multi-directional sensor(s) 210 may be positioned on a surface of respective smart glass units 208. For example, multi-directional sensor(s) 210 may be positioned on an exterior surface of the respective smart glass units 208 (e.g., on a surface of the smart glass unit 208 facing the exterior environment 204) and/or may be positioned at a side edge of the respective smart glass unit 208, at a corner of the respective smart glass unit 208, at a top edge of the respective smart glass unit 208, at another other location on, near, and/or adjacent the respective smart glass unit 208 to receive relatively or about the same amount of light at about the same angle as the respective smart glass unit 208. In some aspects, the multi-directional sensors 210 may be positioned relative to the respective smart glass unit 208 so that multi-directional sensor(s) 210 receives as close to the same amount of light and/or as close to the same angle of light as the respective smart glass unit(s) 208 receives. As shown in FIGS. 2 and 3, respective multi-directional sensors 210 may be positioned on a bottom edge of the respective smart glass units.

As shown in FIG. 3, the system 200 may also include one or more controllers 212, such as a first controller 212a and a second controller 212b. The multi-directional sensor(s) 210 are configured for determining a total amount of radiation received by the respective multi-directional sensors 210 and the respective smart glass units 208, for determining whether the current external environmental conditions are sunny or cloudy, and for determining the angle(s) (e.g., azimuth and elevation) by which the multi-directional sensor 210 and the respective smart glass units 208 receive the light. For example, the first controller 212a may receive one or more signals indicating an amount of light detected by respective sensor elements of the plurality of sensor elements of the first multi-directional sensor 210a. The first controller 212a may receive an indication of sensed light from each of a plurality of sensor elements of the first multi-directional sensor 210a (and/or the second multi-directional sensor 210b), determine a total amount of light or radiation received by the plurality of sensor elements of the first multi-dimensional sensor 210a (and/or the second multi-directional sensor 210b), identify that one sensor element detects a lowest amount light or radiation compared to remaining sensor elements among the plurality of sensor elements of the first-multi-directional sensor 210a (and/or the second multi-directional sensor 210b), and subtract the lowest amount of light or radiation from the total amount of light or radiation to obtain an amount of direct light or radiation received by the first smart glass unit 208a (and/or the second smart glass unit 208b). The first controller 212a may also determine the angle by which the first smart glass unit 208a (and/or the second smart glass unit 208b) receives the light from the light source 206 based on the direct radiation and directions that the respective remaining sensor elements face among the plurality of sensor elements of the first multi-directional sensor 210a (and/or the second multi-directional sensor 210b). The angles from which light is received by the multi-directional sensor may be used to determine an amount of glare and if the smart glass unit is to be tinted (and how much) to reduce or block glare. Regardless of what measurements the multi-directional sensor 210 (e.g., the first multi-directional sensor 210a, the second multi-directional sensor 210b, the third multi-directional sensor 210c) may receive, by taking multiple measurements (e.g., simultaneously, contemporaneously) from the multi-directional sensor 210, the controller (e.g., the first controller 212a, the second controller 212b) may extract multiple different measurements (e.g., total radiation, direct or indirect radiation, azimuth, and elevation) for a variety of relevant environmental (e.g., of the external environment 204) variables.

The first controller 212a may then use the signals from the first multi-directional sensor 210a (and/or the second multi-directional sensor 210b) to determine an amount of tint for the first smart glass unit 208a (and/or the second smart glass unit 208b). For example, when the first controller 212a receives one or more signals from the first multi-directional sensor 210a (and/or the second multi-directional sensor 210b) indicating an amount of light detected by the first multi-directional sensor 210a (and/or the second multi-directional sensor 210b), the first controller 212a may determine a level of tint (e.g., an amount of tint) for the first smart glass unit 208a (and/or the second smart glass unit 208b) to allow for a certain amount of light to enter the interior environment of the building 202 through the first smart glass unit 208a (and/or the second smart glass unit 208b). The first controller 212a may then transmit one or more signals to the first smart glass unit 208a (and/or the second smart glass unit 208b) indicating the determined level of tint to control the tint of the first smart glass unit 208a (and/or the second smart glass unit 208b) (e.g., increase the amount of tint through the first smart glass unit 208a, decrease the amount of tint through the first smart glass unit 208a, or maintain the amount of tint through the first smart glass unit 208a) to allow the certain amount of light to enter the interior environment of the building 202. In some aspects, one or more of the controllers 212 may be positioned within a smart glass unit 208. In some aspects, one or more of the controllers 212 may be positioned external to the smart glass units 208 and within the building 202.

In some aspects, the first controller 212a may be configured to receive a plurality of signal from both the first multi-directional sensor 210a and the second multi-directional sensor 210b. For example, the first smart glass unit 208a and the second smart glass unit 208b may be positioned adjacent each other on a same wall of the building 202 facing the same direction and generally receiving the same amount of light from generally the same direction. The first multi-directional sensor 210a and the second multi-directional sensor 210b may send signals to the first controller 212a for controlling a level of tint of the first smart glass unit 208a and the second smart glass unit 208b, respectively. The first controller 212a may determine that first smart glass unit 208a should have more tinting than the second smart glass unit 208b due to the signals from the respective multi-directional sensor 210a and 210b and send the appropriate solar signals to the respective smart glass units 208a and 208b for controlling the respective tint levels. In some aspects, the first controller 210a may determine that one of the first smart glass unit 208a or the second smart glass unit 208b receives more light than the other and thus sends one or more tint signals to both the first smart glass unit 208a and the second smart glass unit 208b to control the level of tint for both according to greater amount of light received by one of the multi-directional sensors 210a or 210b.

In some aspects, a multi-directional sensor 210 may be configured to sense an amount of light and direction from which the light originates for controlling a tint for multiple smart glass units 208. For example, the first smart glass unit 208a and the second smart glass unit 208b may be positioned adjacent each other on a same wall of the building 202 facing the same direction and generally receiving the same amount of light from generally the same direction. One of the first multi-directional sensor 210a or the second multi-directional sensor 210b may send signals to the first controller 212a for controlling a level of tint of both the first smart glass unit 208a and the second smart glass unit 208b. In other words, signal from the first multi-directional sensor 210a may be used to control, via the controller 212a, the level of tint of both the first smart glass unit 208a and the second smart glass unit 208b without using the second multi-directional sensor 210b. It should be understood that using only one of the first multi-directional sensor 210a or the second multi-directional sensor 210b to send signals to the first controller 212a for controlling a level of tint of both the first smart glass unit 208a and the second smart glass unit 208b may cause both the first smart glass unit 208a and the second smart glass unit 208b to maintain the same amount of tint (e.g., the same amount of tint change) relative to one another.

In some aspects, the system 200 may also include a system controller 214. As described herein, the multi-directional sensor(s) 210 are configured for determining a total amount of radiation received by the respective multi-directional sensor 210 and the respective smart glass unit 208, for determining whether the current external environmental conditions are sunny or cloudy, and for determining the angle(s) (e.g., azimuth and elevation) by which the multi-directional sensor 210 and the respective smart glass unit 208 receives the light. For example, the system controller 214 may receive one or more signals indicating an amount of light detected by respective sensor elements of the plurality of sensor elements of the third multi-directional sensor 210c. For example, the system controller 214 may receive an indication of sensed light from each of a plurality of sensor elements of the third multi-directional sensor 210c, determine a total amount of light or radiation received by the plurality of sensor elements of the third multi-dimensional sensor 210c, identify that one sensor element detects a lowest amount light or radiation compared to remaining sensor elements among the plurality of sensor elements of the third multi-directional sensor 210c, and subtract the lowest amount of light or radiation from the total amount of light or radiation to obtain an amount of direct light or radiation received by the third smart glass unit 208c. The system controller 214 may also determine the angle by which the third smart glass unit 208c receives the light from the light source 206 based on the direct radiation and directions that the respective remaining sensor elements face among the plurality of sensor elements of the third multi-directional sensor 210c. The angles from which light is received by the multi-directional sensor may be used to determine glare and if the smart glass unit is to be tinted (and how much) to reduce or block glare. The system controller 214 may then use the signals from the third multi-directional sensor 210c to determine an amount of tint for the third smart glass unit 208c. For example, when the system controller 214 receives one or more signals from the third multi-directional sensor 210c indicating an amount of light detected by the third multi-directional sensor 210c, the system controller 214 may determine a level of tint (e.g., an amount of tint) for the third smart glass unit 208c to allow for a certain amount of light to enter the interior environment of the building 202 through the third smart glass unit 208c. The system controller 214 may then transmit one or more signals to the second controller 212b indicating the determined level of tint to control the tint of the third smart glass unit 208c (e.g., increase the amount of tint through the third smart glass unit 208c, decrease the amount of tint through the third smart glass unit 208c, or maintain the amount of tint through the third smart glass unit 208c) to allow the certain amount of light to enter the interior environment of the building 202. The second controller 212b may receive the signals from the system controller 214 and instruct the third smart glass unit 208c accordingly to control the tint.

FIG. 4 illustrates a perspective view of an example system 400 including a multi-directional sensor 210 according to some aspects of this disclosure. The system 400 may include one or more same or similar features as the features described with respect to or illustrated in FIGS. 1, 2, 3, 5, 6, 7, 8, 9, and 10. For example, the system 400 may include one or more same or similar features as the features described with respect to the EC system 100 of FIG. 1, the system 200 of FIGS. 2 and 3, the system 500 of FIG. 5, the system 600 of FIG. 6, the system 700 of FIG. 7, the system 800 of FIG. 8, and/or the computer system 1000 of FIG. 10. The system 400 of FIG. 4 and the description provided therewith may be implemented with one or more of the steps of the method 900 of FIG. 9 or used to at least partially perform one or more of the steps of the method 900 of FIG. 9. FIG. 4, as with the other included figures, is shown for illustrative purposes and does not limit either the possible embodiments of the present invention or the claims.

As shown in FIG. 4, the system 400 includes a smart glass unit 208 and a multi-directional sensor 210. As described herein, the multi-directional sensor 210 may be configured for measuring an amount of received light, for transmitting one or more signals indicating an amount of light detected by respective sensor elements of the plurality of sensor elements of the multi-directional sensor, and for determine one or more solar parameters for controlling a tint of the smart glass unit based on the one or more signals. The multi-directional sensor 210 may include at least one sensor element and a plurality of other sensor elements all for individually measuring an amount of received light. For example, the multi-directional sensor 210 may include a first sensor element 402a facing in a first direction 402b orthogonal to a surface of the smart glass unit 208 (e.g., a pane of the smart glass unit 208) and a plurality of other sensor elements facing in different directions that are parallel to the surface of the smart glass unit 208 (e.g., a pane of the smart glass unit 208). In some aspects, the sensor element includes a first sensor element 402a and the plurality of other sensor elements may include a second sensor element 404a, a third sensor element 406a, and a fourth sensor element 408a. As such, the second sensor element 404a may face in an upward direction 404b when the smart glass unit 208 is installed in a wall of the building 202. The third sensor element 406a may face in a third direction 406b, a lateral direction, when the smart glass unit 208 is installed in the wall of the building 202. The fourth sensor element 408a may face in a fourth direction 408b, a lateral direction opposite the third direction 406b, when the smart glass unit 208 is installed in the wall of the building 202. In some aspects, the plurality of other sensor elements may face in directions that are orthogonal to at least one other sensor element. For example, the second sensor element 404a may face in a direction orthogonal to the third sensor element 406a or the fourth sensor element 408a and the third sensor element 406a may face in a direction orthogonal to the fourth sensor element 408a. Additionally, or alternatively, the first sensor element 402a may face in a direction orthogonal to the second sensor element 404a, the third sensor element 406a, and/or the fourth sensor element 408a. In some aspects, when the smart glass unit 208 is installed in a wall of the building 202, the first sensor element 402a may face in the direction orthogonal to the surface of the respective smart glass unit (e.g., a pane of the respective smart glass unit) and towards the exterior environment 204 (e.g., the exterior area) of the building 202. In some aspects, the multi-directional sensor 210 may include a flex circuit including the plurality of sensor elements such that the flex circuit is wrapped around a five (5) to ten (10) millimeter (mm) cube. Each of the individual sensor elements are positioned to face in different directions to individual capture or sense peak light sensitivity.

As described herein, a controller (e.g., the first controller 212a, the second controller 212b, the system controller 214) may receive an indication of sensed light from each of a plurality of sensor elements (e.g., the first sensor element 402a, the second sensor element 404a, the third sensor element 406a, and the fourth sensor element 408a) of the multi-directional sensor 210, determine a total amount of light or radiation received by the plurality of sensor elements of the multi-dimensional sensor 210 (e.g., including whether its cloudy or sunny outside), identify that one sensor element (e.g., the fourth sensor element 408a) detects a lowest amount light or radiation compared to remaining sensor elements (e.g., the first sensor element 402a, the second sensor element 404a, the third sensor element 406a) among the plurality of sensor elements of the first-multi-directional sensor 210a, and subtract the lowest amount of light or radiation from the total amount of light or radiation to obtain an amount of direct light or radiation received by the smart glass unit 208. In some aspects, if all of the sensor elements receive the same or similar amount of light, the controller may also determine the angle by which the smart glass unit 208 receives the light from the light source 206 based on the direct radiation and directions that the respective remaining sensor elements (e.g., the first sensor element 402a, the second sensor element 404a, the third sensor element 406a) face among the plurality of sensor elements of the multi-directional sensor 210. The angles from which light is received by the multi-directional sensor may be used to determine glare and if the smart glass unit is to be tinted (and how much) to reduce or block glare.

The multi-directional sensor 210 may be positioned adjacent (e.g., next to, but not touching) or against the smart glass unit 208. For example, the multi-directional sensor 210 may be positioned adjacent or against the smart glass units 208 to receive the same light (e.g., the same amount to light intensity, about the same amount of light intensity), for example from the light source 206, that is received by the smart glass unit 208 itself. The multi-directional sensor 210 may be positioned on a surface of smart glass unit 208 and/or so that one sensor element of the multi-directional sensor 210 is facing in a same direction as a pane of the smart glass unit 208. For example, one sensor element of the multi-directional sensor 210 may face in a direction towards an external environment (e.g., external environment 204 outside the building 202 of FIG. 2) rather than towards an internal environment (e.g., within the building 202 of FIG. 2) may be positioned on an exterior surface of the respective smart glass units 208 (e.g., on a surface of the smart glass unit 208 facing the exterior environment 204) and/or may be positioned at a side edge of the smart glass unit 208, at a corner of the smart glass unit 208, at a top edge of the smart glass unit 208, at a bottom edge of the smart glass unit 208, at another other location on, near, and/or adjacent the smart glass unit 208 to receive relatively or about the same amount of light at about the same angle as the smart glass unit 208. In some aspects, the multi-directional sensor(s) 210 may be positioned relative to the smart glass unit 208 so that multi-directional sensor(s) 210 receive as close to the same amount of light and/or as close to the same angle of light as the respective smart glass unit(s) 208 receive.

FIG. 5 illustrates a perspective view of another example system 500 including a multi-directional sensor 510 according to some aspects of this disclosure. The system 500 may include one or more same or similar features as the features described with respect to or illustrated in FIGS. 1, 2, 3, 4, 6, 7, 8, 9, and 10. For example, the system 500 may include one or more same or similar features as the features described with respect to the EC system 100 of FIG. 1, the system 200 of FIGS. 2 and 3, the system 400 of FIG. 4, the system 600 of FIG. 6, the system 700 of FIG. 7, the system 800 of FIG. 8, and/or the computer system 1000 of FIG. 10. The system 500 of FIG. 5 and the description provided therewith may be implemented with one or more of the steps of the method 900 of FIG. 9 or used to at least partially perform one or more of the steps of the method 900 of FIG. 9. FIG. 5, as with the other included figures, is shown for illustrative purposes and does not limit either the possible embodiments of the present invention or the claims.

As shown in FIG. 5, the system 500 includes the smart glass unit 208, and a multi-directional sensor 510. The multi-directional sensor 510 may include one or more same or similar features of the multi-directional sensor 210 of FIGS. 2, 3, and 4. For example, the multi-directional sensor 510 may include a first sensor element 502a facing in a first direction 502b that is orthogonal to a surface of the smart glass unit 208. The multi-directional sensor 510 may also include a plurality of other sensor elements including a second sensor element 504a facing a second direction 504b that is parallel to the surface of the smart glass unit 208, a third sensor element 506a facing a third direction 504c that is parallel to the surface of the smart glass unit 208, and a fourth sensor element 508a facing a fourth direction 508b that is parallel to the surface of the smart glass unit 208. In addition, each of the sensor elements of the multi-directional sensor 510 may include light pipes. The light pipes include a column or a tube with open ends to focus or channel light from the respective directions to the respective sensor elements. The light pipes are configured to focus the light for reception by the respective sensors for more accurate light measurement by the respective sensor elements. As shown in FIG. 5, the first light pipe 502c is positioned over the first sensor element 502a such that column or tube extends along the first direction 502b. Similarly, the second light pipe 504c is positioned over the second sensor element 504a such that column or tube extends along the second direction 504b, the third light pipe 506c is positioned over the third sensor element 506a such that column or tube extends along the third direction 506b, and the fourth light pipe 508c is positioned over the fourth sensor element 508a such that column or tube extends along the fourth direction 508b. In some aspects, the sensor elements of the multi-directional sensor 510 may be positioned within a plane and the light pipes (or diffusers, or lenses) may be used to make each sensor element read light from a different direction.

FIG. 6 illustrates a perspective view of an example system 600 according to some aspects of this disclosure. The system 600 may include one or more same or similar features as the features described with respect to or illustrated in FIGS. 1, 2, 3, 4, 5, 7, 8, 9, and 10. For example, the system 600 may include one or more same or similar features as the features described with respect to the EC system 100 of FIG. 1, the system 200 of FIGS. 2 and 3, the system 400 of FIG. 4, the system 500 of FIG. 5, the system 700 of FIG. 7, the system 800 of FIG. 8, and/or the computer system 1000 of FIG. 10. The system 600 of FIG. 6 and the description provided therewith may be implemented with one or more of the steps of the method 900 of FIG. 9 or used to at least partially perform one or more of the steps of the method 900 of FIG. 9. FIG. 6, as with the other included figures, is shown for illustrative purposes and does not limit either the possible embodiments of the present invention or the claims.

As described herein, a smart glass unit system and/or a smart glass unit (e.g., the EC system 100 of FIG. 1, one of the plurality of smart glass units 208 of FIGS. 2, 3, 4, and/or 5) is provided that includes a multi-directional sensor (e.g., the multi-directional sensor 210, the multi-directional sensor 510). For a respective smart glass unit and/or for a respective group of smart glass units, the multi-directional sensor is configured to sense parameters for determining total radiation received, for determining whether the current external environmental conditions are sunny or cloudy, and/or for determining one or more angle(s) (e.g., azimuth and/or elevation) from which solar radiation is received. Thus, for example, parameters for determining total radiation from an external environment, whether the external environment is sunny or cloudy, and/or angle(s) by which radiation or light from a light source (e.g., the Sun) in the external environment reaches the multi-directional sensor 210, and thus the smart glass unit (e.g., a pane of the smart glass unit), may be sensed for controlling a tint level of the smart glass unit. When the smart glass unit is installed in a wall of the building 202 separating an internal environment within the building 202 from the external environment 204 outside the building 202, measurements taken by the multi-directional sensor may be used to control the tint level of the smart glass unit. The measurements may be taken from the multi-directional sensor to regulate the amount of light that passes from the light source in the external environment, through the smart glass unit, and into the internal environment of the building to a desirable level for the occupants therein. The multi-directional sensor may take light measurements at a surface of the smart glass unit to allow for the regulation or control of the tint level of the smart glass unit on a unit-by-unit basis without the complex control scheduling that would otherwise be used. Accordingly, using the multi-directional sensor, knowing the amount of shade that the smart glass unit receives, the location of the Sun at a particular time of day at a particular time of year, and/or which direction the smart glass unit is facing (e.g., north, south, east, or west) may no longer be needed to control the level of tint of the smart glass unit to provide a desirable amount of tinting therethrough.

For example, the system 600 of FIG. 6 includes a scenario where the building 202 having at least one multi-directional sensor 210 for at least one smart glass unit 208 is a located at a southern latitude during summer solstice. As such, at sunrise 602, the light source 206 may provide no direct light on to the smart glass unit 208 and for direct measurement by the multi-directional sensor 210 because the light source 206 is blocked by the building 202. Without having any information about the location of the building 202, the direction that the multi-directional sensor 210 and/or the smart glass unit 208 is facing, the time of day, the weather, and/or the time of year, the multi-directional sensor 210 may sense an amount of light received and angle(s) by which the light is received for determining a level of tint for the smart glass unit 208. Similarly, at solar noon 604, the light source 206 may provide direct light on to the smart glass unit 208 and for direct measurement by the multi-directional sensor 210 because no obstruction exists between the light source 206 and the smart glass unit 208 and the multi-directional sensor 210. Without having any information about the location of the building 202, the direction that the multi-directional sensor 210 and/or the smart glass unit 208 is facing, the time of day, the weather, and/or the time of year, the multi-directional sensor 210 may sense an amount of light received, a first angle 608a (e.g., an elevation angle) by which the light is received, and/or a second angle 608b (e.g., an azimuth angle, a lateral angle) for determining a level of tint for the smart glass unit 208. In this case, because the building 202 is located at the southern latitude during summer solstice, the first angle 608a by which the smart glass unit 208 and the multi-directional sensor 210 receives light from the light source 206 is steep, for example, between 89.9 degrees and 70 degrees (e.g., 86 degrees). Similarly, at sunset 606, the light source 206 may provide no direct light on to the smart glass unit 208 and for direct measurement by the multi-directional sensor 210 because the light source 206 is again blocked by the building 202. Without having any information about the location of the building 202, the direction that the multi-directional sensor 210 and/or the smart glass unit 208 is facing, the time of day, the weather, and the time of year, the multi-directional sensor 210 may sense an amount of light received and an angle by which the light is received for determining a level of tint for the smart glass unit 208.

FIG. 7 illustrates a perspective view of an example system 700 according to some aspects of this disclosure. The system 700 may include one or more same or similar features as the features described with respect to or illustrated in FIGS. 1, 2, 3, 4, 5, 6, 8, 9, and 10. For example, the system 700 may include one or more same or similar features as the features described with respect to the EC system 100 of FIG. 1, the system 200 of FIGS. 2 and 3, the system 400 of FIG. 4, the system 500 of FIG. 5, the system 600 of FIG. 6, the system 800 of FIG. 8, and/or the computer system 1000 of FIG. 10. The system 700 of FIG. 7 and the description provided therewith may be implemented with one or more of the steps of the method 900 of FIG. 9 or used to at least partially perform one or more of the steps of the method 900 of FIG. 9. FIG. 7, as with the other included figures, is shown for illustrative purposes and does not limit either the possible embodiments of the present invention or the claims.

The system 700 of FIG. 7 may include one or more features of the system 600 of FIG. 6. For example, the system 700 of FIG. 7 includes a scenario where the building 202 having at least one multi-directional sensor 210 for at least one smart glass unit 208 is a located at the southern latitude but is during winter solstice rather than the summer solstice. As such, at sunrise 702, the light source 206 may provide a small amount of direct light on to the smart glass unit 208 and for direct measurement by the multi-directional sensor 210 because at least some light from the light source 206 reaches the building 202. Without having any information about the location of the building 202, the direction that the multi-directional sensor 210 and/or the smart glass unit 208 is facing, the time of day, the weather, and the time of year, the multi-directional sensor 210 may sense an amount of light received and an angle by which the light is received for determining a level of tint for the smart glass unit 208. Similarly, at solar noon 704, the light source 206 may provide direct light on to the smart glass unit 208 and for direct measurement by the multi-directional sensor 210 because no obstruction exists between the light source 206 and the smart glass unit 208 and the multi-directional sensor 210. Without having any information about the location of the building 202, the direction that the multi-directional sensor 210 and/or the smart glass unit 208 is facing, the time of day, the weather, and/or the time of year, the multi-directional sensor 210 may sense an amount of light received, a first angle 708a (e.g., an elevation angle) by which the light is received, and/or a second angle 708b (e.g., an azimuth angle, a lateral angle) for determining a level of tint for the smart glass unit 208. In this case, because the building 202 is located at the southern latitude during winter solstice, the first angle 708a by which the smart glass unit 208 and the multi-directional sensor 210 receives light from the light source 206 is not as steep as during summer solstice, for example, between 30 degrees and 50 degrees (e.g., 38 degrees). Similarly, at sunset 706, the light source 206 may provide a small amount of direct light on to the smart glass unit 208 and for direct measurement by the multi-directional sensor 210 because at least some light from the light source 206 reaches the building 202. Without having any information about the location of the building 202, the direction that the multi-directional sensor 210 and/or the smart glass unit 208 is facing, the time of day, the weather, and the time of year, the multi-directional sensor 210 may sense an amount of light received and an angle by which the light is received for determining a level of tint for the smart glass unit 208.

FIG. 8 illustrates a cross-sectional view of an example system 800 according to some aspects of this disclosure. The system 800 may include one or more same or similar features as the features described with respect to or illustrated in FIGS. 1, 2, 3, 4, 5, 6, 7, 9, and 10. For example, the system 800 may include one or more same or similar features as the features described with respect to the EC system 100 of FIG. 1, the system 200 of FIGS. 2 and 3, the system 400 of FIG. 4, the system 500 of FIG. 5, the system 600 of FIG. 6, the system 700 of FIG. 7, and/or the computer system 1000 of FIG. 10. The system 800 of FIG. 8 and the description provided therewith may be implemented with one or more of the steps of the method 900 of FIG. 9 or used to at least partially perform one or more of the steps of the method 900 of FIG. 9. FIG. 8, as with the other included figures, is shown for illustrative purposes and does not limit either the possible embodiments of the present invention or the claims.

In some aspects, a multi-directional sensor may be used in retrofit applications. For example, as shown in FIG. 8, the system 800 may include a building 802 separating an external environment 804 outside the building 802 for an internal environment 814 within the building 802. The building 802 may have an existing pane 806 (e.g., window, another smart glass unit) permitting light to pass from the external environment 804 and into the internal environment 814. Subsequently, a new or retrofit smart glass unit 808 may be installed into the building 802. For example, the retrofit smart glass unit 808 may be installed at the location of the existing pane 806 from the interior environment 814 forming a space 812 between the existing pane 806 and the retrofit smart glass unit 814. The multi-directional sensor 210 (or 510) may be installed in the space 812 for multi-directional sensing as described herein.

FIG. 9 illustrates an example method 900 according to some aspects of this disclosure. The method 900 may be implemented using and/or with one or more same or similar features as the features described with respect to or illustrated in FIGS. 1, 2, 3, 4, 5, 6, 7, 8, and 10. For example, the method 900 may be implemented using and/or with one or more same or similar features as the features described with respect to the EC system 100 of FIG. 1, the system 200 of FIGS. 2 and 3, the system 400 of FIG. 4, the system 500 of FIG. 5, the system 600 of FIG. 6, the system 700 of FIG. 7, the system 800 of FIG. 8, and/or the computer system 1000 of FIG. 10. FIG. 9, as with the other included figures, is shown for illustrative purposes and does not limit either the possible embodiments of the present invention or the claims.

At step 901, a controller receives one or more signals from respective sensor elements of a plurality of sensor elements indicating an amount of light sensed by the respective sensor elements. The respective sensor elements may be oriented in different directions. In some aspects, the respective sensor elements may be positioned at different locations on a building and oriented to face in different directions from the building. For example, sensor elements positioned at different locations on a building (e.g., the building 202) may each sense an amount of light received from a light source (e.g., the light source 206, the Sun) and send signals to the controller (e.g., the first controller 212a of FIG. 3, the second controller 212b of FIG. 3, the system controller 214 of FIG. 3, the computer system 1000 of FIG. 10) indicating the amount of light sensed by each of the sensor elements. In some aspects, the respective sensor elements may be sensor elements of a unitary multi-directional sensor (e.g., multi-directional sensor 210, multi-directional sensor 510) as described herein. For example, sensor elements positioned on a multi-directional sensor (e.g., sensors mounted on a flex circuit at least partially surrounding a cuboid-like object) may each sense an amount of light received from a light source (e.g., the light source 206, the Sun, a brightly lit building near the building 202, a street or park light near the building 202) and send signals to the controller indicating the amount of light sensed by each of the sensor elements.

At step 903, the controller may determine light information for a location (e.g., the location of the building 202, the location of the first smart glass unit 208a, a direction that the first smart glass unit 208a is facing, the location of the second smart glass unit 208b, a direction that the second smart glass unit 208b is facing, the location of the third smart glass unit 208c, and/or a direction that the third smart glass unit 208c is facing). The light information may be determined based on the amount of light sensed by the respective sensor elements and the different orientations of the respective sensor elements. In some aspects, the light information may include an angular position (e.g., the first solar angle 608a of FIG. 6, the second solar angle 608b of FIG. 6, the first solar angle 708a of FIG. 7, the second solar angle 708b of FIG. 7) of a direct light source (e.g., the light source 206, the Sun, a brightly lit building near the building 202, a street or park light near the building 202) with respect to the location. Additionally, or alternatively, the light information may include information relating an amount of direct light to an amount of indirect light at the location. For example, information relating an amount of direct light to an amount of indirect light may include a ratio or percentage of direct light to indirect light at the location. The ratio may be indicative of a sunny, partly cloudy, or completely cloudy day. In some aspects, a controller may determine the information relating the amount of direct light to the amount of indirect light at the location based on determining, by the controller, a lowest amount light received by one sensor element of the plurality of sensor elements compared to remaining sensor elements of the plurality of sensor elements. Subsequently, the controller may subtract the lowest amount of light from a total amount of light received by the sensor element at the location to obtain the amount of direct light received by the sensor element at the location.

At step 905, the controller (e.g., the first controller 212a of FIG. 3, the second controller 212b of FIG. 3, the system controller 214 of FIG. 3, the computer system 1000 of FIG. 10) may send one or more control signals to at least one smart glass unit to control a level of tint of the at least one smart glass unit based on the determined light information. For example, when the controller determines that the amount of direct light received by the plurality of sensor elements has a relatively high intensity (e.g., compared to a previous intensity) and/or is received at one or more angles to provide a relatively great amount of direct light (e.g., compared to previous amount of direct light) on to the at least one smart glass unit, the controller may send one or more control signals to the at least one smart glass unit to maintain or increase a level of tint of the at least one smart glass unit. As another example, when the controller determines that the amount of direct light received by the plurality of sensor elements has a relatively low intensity (e.g., compared to a previous intensity) and/or is received at one or more angles to provide a relatively small amount of direct light (e.g., compared to previous amount of direct light) on to the at least one smart glass unit, the controller may send one or more control signals to the at least one smart glass unit to maintain or decrease a level of tint of the at least one smart glass unit.

In some aspects, the plurality of sensor elements may include three sensor elements. In some aspects, the plurality of sensor elements may include at least four sensor elements. When the plurality of sensor elements includes at least four sensor elements, the controller (e.g., the first controller 212a of FIG. 3, the second controller 212b of FIG. 3, the system controller 214 of FIG. 3, the computer system 1000 of FIG. 10) may also determine whether an external environment (e.g., external environment 204 of FIG. 2, external environment 804 of FIG. 8) includes one of a cloudy condition or a sunny condition. For example, the controller may determine that respective sensor elements of the plurality of sensor elements sense a same or similar amount of light based on the one or more signals indicating the amount of light sensed by the respective sensor elements. The controller may then determine that the external environment includes the cloudy condition based on the respective sensor elements of the plurality of sensor elements sensing the same or similar amount of light. As another example, the controller may determine that at least one sensor element of the plurality of sensor elements senses a different amount of light compared to at least one other sensor element of the plurality of sensor elements based on the one or more signals indicating the amount of light sensed by the respective sensor elements. The controller may then determine that the external environment includes the sunny condition based on the at least one sensor element of the plurality of sensor elements sensing the different amount of light compared to the at least one other sensor element of the plurality of sensor elements.

In some aspects, a system is provided. The system includes a smart glass unit having at least one pane. The system also includes a multi-directional light sensor. The multi-directional sensor includes a sensor element facing in a direction orthogonal to a surface of the pane. The multi-directional sensor also includes a plurality of other sensor elements facing in different directions that are parallel to the surface of the pane.

In some aspects, the sensor element includes a first sensor element. In some aspects, the plurality of other sensor elements includes a second sensor element, a third sensor element, and a fourth sensor element. The second sensor element faces in an upward direction (e.g., towards the sky and/or away from ground in a direction orthogonal to the ground, in direction opposite gravity) when the smart glass unit is installed in a wall of a building. The third sensor element faces in a first lateral direction when the smart glass unit is installed in the wall of the building. The fourth sensor element faces in a second lateral direction, opposite the first lateral direction, when the smart glass unit is installed in the wall of the building. In some aspects, when the smart glass unit is installed in a wall of a building, the sensor element faces in the direction orthogonal to the surface of the pane and towards an exterior area of the building. In some aspects, the multi-directional light sensor is positioned at a central lower edge of the pane. For example, the multi-directional light sensor may be positioned and resting on a surface upon which the smart glass unit is resting. The multi-direction sensor may, additionally, or alternatively, be positioned equidistant or about equidistant from later edges of the smart glass unit. In some aspects, at least some of the plurality of other sensor elements face in directions that are orthogonal to each other. In some aspects, the system further includes an existing window-pane. The smart glass unit includes a retrofit smart glass unit. The retrofit smart glass unit is positioned adjacent an interior surface of the existing window-pane. The multi-directional light sensor is positioned between the existing window-pane and the retrofit smart glass unit. In some aspects, the sensor element and the plurality of other sensor elements are configured to detect at least one of a total light radiation, sunny and cloud conditions, or a solar angle.

In some aspects, a system is provided. The system includes a smart glass unit configured to modulate a tint for permitting light to pass therethrough. The system also includes a multi-directional light sensor. The multi-directional light sensor includes a sensor element facing in a direction orthogonal to a surface of the smart glass unit. The multi-directional light sensor also includes a plurality of other sensor elements facing in different directions that are orthogonal to the direction that the sensor element faces. The system further includes a controller. The controller is configured to receive one or more signals indicating an amount of light detected by respective sensor elements of the sensor element and of the plurality of other sensor elements. The controller is also configured to generate one or more tint signals for controlling a tint of the smart glass unit based on the one or more signals.

In some aspects, the one or more tint signals for controlling the tint of the smart glass unit are based on an angle by which the smart glass unit receives light from a light source. In some aspects, the plurality of other sensor elements includes three other sensor elements. Generating the one or more tint signals for controlling the tint of the smart glass unit based on the one or more signals includes determining a total amount of radiation received by the sensor element and the plurality of other sensor elements, identifying that a first sensor element detects a lowest amount radiation compared to remaining sensor elements among the sensor element and the plurality of other sensor elements, subtracting the lowest amount of radiation from the total amount of radiation to obtain an amount of direct radiation received by the smart glass unit, and determining the angle by which the smart glass unit receives the light from the light source based on the direct radiation and directions that the respective remaining sensor elements face among the sensor element and the plurality of other sensor elements. In some aspects, the one or more tint signals indicates a total received radiation. In some aspects, the one or more tint signals indicates an amount of cloud cover in an external environment. In some aspects, the controller is positioned within or adjacent to the smart glass unit. In some aspects, the controller is positioned at a location remote from the smart glass unit. In some aspects, the controller is positioned within or adjacent to the multi-directional light sensor. In some aspects, the sensor element includes a first sensor element. The plurality of other sensor elements includes a second sensor element, a third sensor element, and a fourth sensor element. The second sensor element faces in an upward direction (e.g., towards the sky and/or away from the ground) when the smart glass unit is installed in a wall of a building. The third sensor element faces in a first lateral direction when the smart glass unit is installed in the wall of the building. The fourth sensor element faces in a second lateral direction, opposite the first lateral direction, when the smart glass unit is installed in the wall of the building. In some aspects, when the smart glass unit is installed in a wall of a building, the sensor element faces in the direction orthogonal to the surface of the smart glass unit and towards an exterior area of the building. In some aspects, the multi-directional light sensor is positioned at a central lower edge of a pane of the smart glass unit. In some aspects, at least some of the plurality of other sensor elements face in directions that are orthogonal to each other.

In some aspects, a method is provided. The method includes receiving, by a controller, one or more signals from respective sensor elements of a plurality of sensor elements indicating an amount of light sensed by the respective sensor elements. The respective sensor elements of the plurality of sensor elements are oriented in different directions. The method also includes determining, by the controller, light information for a location. The light information is determined based on the amount of light sensed by the respective sensor elements and the different orientations of the respective sensor elements. The light information includes one or more of an angular position of a direct light source with respect to the location, or information relating an amount of direct light to an amount of indirect light at the location. The method further includes sending, by the controller, one or more control signals to at least one smart glass unit to control a level of tint of the at least one smart glass unit based on the determined light information.

In some aspects, determining, by the controller, the information relating the amount of direct light to the amount of indirect light at the location includes determining, by the controller, a lowest amount light received by one sensor element of the plurality of sensor elements compared to remaining sensor elements of the plurality of sensor elements, and subtracting the lowest amount of light from a total amount of light received by the sensor element at the location to obtain the amount of direct light received by the sensor element at the location. In some aspects, the plurality of sensor elements comprises three sensor elements. In some aspects, the plurality of sensor elements includes at least four sensor elements, and the method further includes determining, by the controller, whether an external environment includes one of a cloudy condition or a sunny condition. In some aspects, determining, by the controller, that the external environment includes the cloudy condition includes determining that the respective sensor elements of the plurality of sensor elements sense a same or similar amount of light based on the one or more signals indicating the amount of light sensed by the respective sensor elements, and determining that the external environment includes the cloudy condition based on the respective sensor elements of the plurality of sensor elements sensing the same or similar amount of light. In some aspects, determining, by the controller, that the external environment includes the sunny condition includes determining that at least one sensor element of the plurality of sensor elements senses a different amount of light compared to at least one other sensor element of the plurality of sensor elements based on the one or more signals indicating the amount of light sensed by the respective sensor elements, and determining that the external environment includes the sunny condition based on the at least one sensor element of the plurality of sensor elements sensing the different amount of light compared to the at least one other sensor element of the plurality of sensor elements. In some aspects, the plurality of sensor elements are components of a unitary multi-directional sensor.

FIG. 10 is a block diagram illustrating a computer system 1000 according to some aspects, as well as various other systems, components, services or devices described herein. The computer system 1000, for example, may be included in the controller and/or system controllers described herein with respect to FIGS. 1, 2, 3, 4, 5, 6, 7, 8, and 9 as well as a combination one or more steps from any of the methods described herein. For example, computer system 1000 may implement a control unit configured to implement and/or utilize the features, methods, mechanisms and/or techniques described herein, in different embodiments. Computer system 1000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of computing device.

Computer system 1000 includes one or more processors 1010 (any of which may include multiple cores, which may be single or multi-threaded) coupled to a system memory 1020 via an input/output (I/O) interface 1030. Computer system 1000 further includes a network interface 1040 coupled to I/O interface 1030. In various embodiments, computer system 1000 may be a uniprocessor system including one processor 1010, or a multiprocessor system including several processors 1010 (e.g., two, four, eight, or another suitable number). Processors 1010 may be any suitable processors capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA. The computer system 1000 also includes one or more network communication devices (e.g., network interface 1040) for communicating with other systems and/or components over a communications network (e.g., Internet, LAN, etc.).

For example, a control unit may receive information and/or commands from one or more other devices requesting that one or more EC devices be changed to a different tint level using the systems, methods and/or techniques described herein. For instance, a user may request a tint change via a portable remote-control device (e.g., a remote control), a wall mounted (e.g., hard wired) device, or an application executing on any of various types of devices (e.g., a portable phone, smart phone, tablet and/or desktop computer are just a few examples).

In the illustrated embodiment, computer system 1000 is coupled to one or more portable storage devices 1080 via device interface 1070. In various embodiments, portable storage devices 1080 may correspond to disk drives, tape drives, solid state memory, other storage devices, or any other persistent storage device. Computer system 1000 (or a distributed application or operating system operating thereon) may store instructions and/or data in portable storage devices 1080, as desired, and may retrieve the stored instruction and/or data as needed. In some embodiments, portable device(s) 1080 may store information regarding one or EC devices, such as information regarding design parameters, etc. usable by a controller when changing tint levels using the techniques described herein.

Computer system 1000 includes one or more system memories 1020 that can store instructions and data accessible by processor(s) 1010. In various embodiments, system memories 1020 may be implemented using any suitable memory technology, (e.g., one or more of cache, static random-access memory (SRAM), DRAM, RDRAM, EDO RAM, DDR 10 RAM, synchronous dynamic RAM (SDRAM), Rambus RAM, EEPROM, non-volatile/Flash-type memory, or any other type of memory). System memory 1020 may contain program instructions 1025 that are executable by processor(s) 1010 to implement the methods and techniques described herein. In various embodiments, program instructions 1025 may be encoded in platform native binary, any interpreted language such as Java™ bytecode, or in any other language such as C/C++, Java™, etc., or in any combination thereof. For example, in the illustrated embodiment, program instructions 1025 include program instructions executable to implement the functionality of a control unit, a stack voltage measurement module, an electron spin resonance (ESR) module, an open circuit voltage (OCV) module, a supervisory control system, local controller, project database, etc., in different embodiments. In some embodiments, program instructions 1025 may implement a control unit configured to implement and/or utilize the features, methods, mechanisms and/or techniques described herein, and/or other components.

In some embodiments, program instructions 1025 may include instructions executable to implement an operating system (not shown), which may be any of various operating systems, such as UNIX, LINUX, Solaris™, MacOS™, Windows™, etc. Any or all of program instructions 1025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 1000 via I/O interface 1030. A non-transitory computer-readable storage medium may also include any volatile or non-volatile media such as RAM (e.g., SDRAM, DDR SDRAM, RDRAM, SRAM, etc.), ROM, etc., that may be included in some embodiments of computer system 1000 as system memory 1020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 1040.

In one embodiment, I/O interface 1030 may coordinate I/O traffic between processor 1010, system memory 1020 and any peripheral devices in the system, including through network interface 1040 or other peripheral interfaces, such as device interface 1070. In some aspects, the network interface 1040 and/or the device interface 1070 may include a transceiver to wirelessly communicate with the other devices 1060 and/or the portable devices 1080. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. Also, in some embodiments, some or all of the functionality of I/O interface 1030, such as an interface to system memory 1020, may be incorporated directly into processor 1010.

Network interface 1040 may allow data to be exchanged between computer system 1000 and other devices attached to a network, such as other computer systems 1060. In addition, network interface 1040 may allow communication between computer system 1000 and various I/O devices and/or remote storage devices. Input/output devices may, in some embodiments, include one or more display terminals, keyboards, keypads, touchpads, scanning devices, voice or optical recognition devices, or any other devices suitable for entering or retrieving data by one or more computer systems 1000. Multiple input/output devices may be present in computer system 1000 or may be distributed on various nodes of a distributed system that includes computer system 1000. In some embodiments, similar input/output devices may be separate from computer system 1000 and may interact with one or more nodes of a distributed system that includes computer system 1000 through a wired or wireless connection, such as over network interface 1040. Network interface 1040 may commonly support one or more wireless networking protocols (e.g., Wi-Fi/IEEE 802.11, or another wireless networking standard). However, in various embodiments, network interface 1040 may support communication via any suitable wired or wireless general data networks, such as other types of Ethernet networks, for example. Additionally, network interface 1040 may support communication via telecommunications/telephony networks such as analog voice networks or digital fiber communications networks, via storage area networks such as Fibre Channel SANs, or via any other suitable type of network and/or protocol. In various embodiments, computer system 1000 may include more, fewer, or different components than those illustrated in FIG. 10 (e.g., displays, video cards, audio cards, peripheral devices, other network interfaces such as an ATM interface, an Ethernet interface, a Frame Relay interface, etc.)

The various methods as illustrated in the figures and described herein represent example embodiments of methods. The methods may be implemented manually, in software, in hardware, or in a combination thereof. The order of any method may be changed, and various elements may be added, reordered, combined, omitted, modified, etc.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed is:

1. A system comprising:
a smart glass unit having at least one pane; and
a multi-directional light sensor, wherein the multi-directional light sensor comprises:
a sensor element facing in a direction orthogonal to a surface of the pane, and
a plurality of other sensor elements facing in different directions that are parallel to the surface of the pane.

2. The system of claim 1, wherein the sensor element comprises a first sensor element, wherein the plurality of other sensor elements comprise a second sensor element, a third sensor element, and a fourth sensor element, wherein the second sensor element faces in an upward direction when the smart glass unit is installed in a wall of a building, wherein the third sensor element faces in a first lateral direction when the smart glass unit is installed in the wall of the building, and wherein the fourth sensor element faces in a second lateral direction, opposite the first lateral direction, when the smart glass unit is installed in the wall of the building.

3. The system of claim 1, wherein when the smart glass unit is installed in a wall of a building, the sensor element faces in the direction orthogonal to the surface of the pane and towards an exterior area of the building.

4. The system of claim 1, wherein the multi-directional light sensor is positioned at a central lower edge of the pane.

5. The system of claim 1, wherein the plurality of other sensor elements face in directions that are orthogonal to each other.

6. The system of claim 1, wherein the system further comprises an existing window-pane, wherein smart glass unit comprises a retrofit smart glass unit, wherein the retrofit smart glass unit is positioned adjacent an interior surface of the existing window-pane, and wherein the multi-directional light sensor is positioned between the existing window-pane and the retrofit smart glass unit.

7. The system of claim 1, the sensor element and the plurality of other sensor elements are configured to detect at least one of a total light radiation, sunny and cloud conditions, or a solar angle.

8. The system of claim 1, further comprising a plurality of smart glass units and a plurality of multi-directional sensors, wherein respective smart glass units of the plurality of smart glass units are associated with different individual multi-directional sensors of the plurality of multi-directional sensors.

9. A system comprising:
a smart glass unit configured to modulate a tint for permitting light to pass therethrough;
a multi-directional light sensor, wherein the multi-directional light sensor comprises:
a sensor element facing in a direction orthogonal to a surface of the smart glass unit, and
a plurality of other sensor elements facing in different directions that are orthogonal to the direction that the sensor element faces; and
a controller configured to:
receive one or more signals indicating an amount of light detected by respective sensor elements among the sensor element and of the plurality of other sensor elements, and
generate one or more tint signals for controlling a tint of the smart glass unit based on the one or more signals.

10. The system of claim 9, wherein the one or more tint signals for controlling the tint of the smart glass unit indicates an angle by which the smart glass unit receives light from a light source.

11. The system of claim 9, wherein the plurality of other sensor elements comprises three other sensor elements, and wherein generating the one or more tint signals for controlling the tint of the smart glass unit based on the one or more signals comprises:
determining a total amount of radiation received by the sensor element and the plurality of other sensor elements;
identifying that a first sensor element detects a lowest amount of radiation compared to remaining sensor elements among the sensor element and the plurality of other sensor elements;
subtracting the lowest amount of radiation from the total amount of radiation to obtain an amount of direct radiation received by the smart glass unit; and
determining the angle by which the smart glass unit receives the light from the light source based on the direct radiation and directions that the respective remaining sensor elements face among the sensor element and the plurality of other sensor elements.

12. The system of claim 9, wherein when the smart glass unit is installed in a wall of a building, the sensor element faces in the direction orthogonal to the surface of the smart glass unit and towards an exterior area of the building.

13. The system of claim 9, wherein the multi-directional light sensor is positioned at a central lower edge of a pane of the smart glass unit.

14. The system of claim 9, wherein at least some of the plurality of other sensor elements face in directions that are orthogonal to each other.

15. A method comprising:
receiving, by a controller, one or more signals from respective sensor elements of a plurality of sensor elements indicating an amount of light sensed by the respective sensor elements, wherein the respective sensor elements of the plurality of sensor elements are oriented in different directions;
determining, by the controller, light information for a location, wherein the light information is determined based on the amount of light sensed by the respective sensor elements and the different orientations of the respective sensor elements, and wherein the light information includes one or more of:
an angular position of a direct light source with respect to the location, or
information relating an amount of direct light to an amount of indirect light at the location; and
sending, by the controller, one or more control signals to at least one smart glass unit to control a level of tint of the at least one smart glass unit based on the determined light information.

16. The method of claim 15, wherein determining, by the controller, the information relating the amount of direct light to the amount of indirect light at the location comprises:
determining, by the controller, a lowest amount light received by one sensor element of the plurality of sensor elements compared to remaining sensor elements of the plurality of sensor elements;
subtracting the lowest amount of light from a total amount of light received by the sensor element at the location to obtain the amount of direct light received by the sensor element at the location.

17. The method of claim 15, wherein the plurality of sensor elements comprises three sensor elements.

18. The method of claim 15, wherein the plurality of sensor elements comprises at least four sensor elements, and wherein the method further comprises determining, by the controller, whether an external environment includes one of a cloudy condition or a sunny condition.

19. The method of claim 18, wherein determining, by the controller, that the external environment includes the cloudy condition comprises:
determining that the respective sensor elements of the plurality of sensor elements sense a same or similar amount of light based on the one or more signals indicating the amount of light sensed by the respective sensor elements; and
determining that the external environment includes the cloudy condition based on the respective sensor elements of the plurality of sensor elements sensing the same or similar amount of light.

20. The method of claim 18, wherein determining, by the controller, that the external environment includes the sunny condition comprises:
determining that at least one sensor element of the plurality of sensor elements senses a different amount of light compared to at least one other sensor element of the plurality of sensor elements based on the one or more signals indicating the amount of light sensed by the respective sensor elements; and
determining that the external environment includes the sunny condition based on the at least one sensor element of the plurality of sensor elements sensing the different amount of light compared to the at least one other sensor element of the plurality of sensor elements.
